(19) United States
(12) Patent Application Publication
(10) Pub. No.: US 2011/0102312 A1
(43) Pub. Date: May 5, 2011

(54) DISPLAY DEVICE

(75) Inventor: Shiyoshi Cho, Yokkaichi-shi (JP)

(73) Assignee: SHARP KABUSHIKI KAISHA, Osaka-shi, Osaka (JP)

(21) Appl. No.: 12/996,393

(22) PCT Filed: Mar. 2, 2009
(86) PCT No.: PCT/JP2009/053839

§ 371 Date: Dec. 6, 2010

(30) Foreign Application Priority Data
Jun. 11, 2008 (JP) 2008-152444

(51) Int. Cl. G09G 3/36

(52) U.S. Cl. 345/102; 345/87

(57) ABSTRACT

A display device such that even if the display device is large size, opening and closing a cabinet of the display device is easy and maintenance of the inside of the display device is easy. A display device (1) includes a cabinet (4) including a front case (41) accommodating a liquid crystal panel (2) and a back case (42) accommodating a backlight unit (3), and the front case (41) and the back case (42) are fitted with each other such that periphery surfaces of the front case (41) cover periphery surfaces of the back case (42). The periphery surfaces of the front case (41) include mobile portions (411a, 412a, 413a, 414a) having hinge structures such that the mobile portions are capable of being rotated with respect to immobile portions (411b, 412b, 413b, 414b).

### TECHNICAL FIELD

The present invention relates to a display device, and specifically relates to a display device favorably used for a large size liquid crystal display device.

### BACKGROUND ART

Conventionally, a liquid crystal display device equipped with a backlight that is constituted of a liquid crystal panel and a backlight unit is in widespread use. This type of liquid crystal display device has a configuration such that a cabinet accommodates components including the liquid crystal panel and the backlight unit. When performing maintenance of the liquid crystal display device such as change of the backlight, it is necessary to open the cabinet for access to the inside of the display device. In the conventional liquid crystal display device, change of the backlight is generally performed by laying the display device and opening the liquid crystal panel.

In recent years, a screen of a display device has been increasing in size as seen in a big-screen television. For example, in the case of a large size liquid crystal display device with a 40-inch or more diagonal screen, it is not easy to lay the display device, detach the liquid crystal panel, and get access to the backlight unit, unlike a small size liquid crystal display device. Because the large size liquid crystal display device is heavy and large, it is extremely difficult for one operator to lay the display device, lift up the liquid crystal panel, and open the cabinet.

In order to solve such a problem, a liquid crystal display device including a cabinet that is constituted of two members including a front case that accommodates a liquid crystal panel and a back case that accommodates a backlight unit is publicly known (see Japanese Patent Application Laid-Open Publications Nos. Hei 07-28056 and 2007-232937). This type of liquid crystal display device is provided with a hinge on either one of right and left side surfaces of the cabinet, and the cabinet is opened having a rotation axis at the hinge by rotating the front case accommodating the liquid crystal panel in a horizontal direction while the liquid crystal panel maintains its normal installation position such that the liquid crystal panel surface is vertical.

### SUMMARY OF INVENTION

### Technical Problem

Usually, maintenance of a large size display device is performed at its installation site by an operator such as a service engineer because the large size display device is not easily transported or moved. In the case of a cabinet of a conventional liquid crystal display device 100 shown in FIG. 6A, the left side of a liquid crystal panel 102 (a front case 101) of the cabinet is rotatably supported by a hinge structure such as a hinge 105. Thus, opening the cabinet by rotating the front case 101 with the right side surface of the display device 100 becoming an opening side provides access to a backlight 104 that is installed inside a back case 103.

When opening the cabinet for maintenance of the conventional display device, only one side is openable. For example, in the display device 100 shown in FIG. 6A, only the right side is opened and closed. Thus, if the display device is installed in such a site that a wall is located on the right side, the display device should be moved on the occasion of opening the cabinet. However, much time and effort are required for moving a large size display device.

It is considered that change of the backlight that is located on the hinge 105 side, the upper side, or the lower side must be easily performed if the cabinet can be opened from the side where the backlight to be changed is located. However, only one side of the cabinet can be opened in the conventional display device, and it is impossible to open a desired side of the cabinet.

The conventional display device has such a fitting structure that the back case 103 is inserted into the front case 101 as shown in FIGS. 6B and 6C. However, in a fitting structure that the front case 101 and the back case 103 are tightly fitted with each other, the insertion of the back case 103 into the front case 101 is extremely difficult. Especially if the conventional display device is large, the insertion of the back case 103 into the front case 101 is much more difficult. To be specific, in the large size display device, a large force is applied to the hinge section of the cabinet by weight of the cabinet, and the cabinet is easily deformed. In such a case, the front case 101 and the back case 103 are brought into contact with each other, and it becomes much harder to insert the back case 103 into the front case 101.

An object of the invention is to overcome the problems described above and to provide a display device such that even if the display device is large, a cabinet of the display device is easily opened and closed, and maintenance of the inside of the display device is easy.

### Solution to Problem

In order to overcome the problems described above, preferred embodiments of the present invention provide a display device including a cabinet that includes a first case and a second case that are fitted with each other and accommodates components of the display device, wherein an opening surface of the first case is opposed to the second case, the first case and the second case are fitted with each other in such a manner that periphery surfaces of the first case cover periphery surfaces of the second case, each of at least two of the periphery surfaces of the first case is divided into an immobile portion and a mobile portion that are arranged along a back and forth direction, the mobile portions are positioned on the opening surface side of the first case, and the mobile portions are capable of being rotated outward from the first case with respect to the immobile portions.

### Advantageous Effects of Invention

In the display device according to the preferred embodiments of the present invention in which each of the at least two of the periphery surfaces of the first case is divided into the immobile portion and the mobile portion that are arranged along the back and forth direction, the mobile portions are located on the opening surface side of the first case, and the mobile portions are capable of being rotated outward from the first case with respect to the immobile portions, so that it is possible to fit the first case and the second case with each other with the mobile portions being opened at the time of closing the cabinet, and therefore, the fitting operation between the first case and the second case is easy. In addition, even if the first case and the second case have such sizes that the cases are tightly fitted with each other, the cabinet can be easily closed.

In the display device according to the preferred embodiments of the present invention, the first case can be opened having the rotation axis at the mobile portion. Because the display device includes the at least two mobile portions, the position to open and close the first case can be arbitrarily selected from a plurality of positions according to the installation site and the maintenance site of the inside of the display device. Because an optimum position can be selected as the position to open and close the cabinet of the display device, it is not necessary to move the display device for opening and closing the cabinet unlike the conventional case, and the opening and closing operation is easy. In addition, in the display device according to the present invention, the position to open and close the cabinet that is most favorable for maintenance can be selected, and therefore, maintenance of the inside of the cabinet is easy.

As described above, according to the present invention, even if the display device is large, the cabinet of the display device can be easily opened, the cases can be easily fitted with each other at the time of closing the cabinet, and an opening side that is most favorable for the opening and closing operation can be selected. Thus, easy maintenance of the display device is achieved.

### BRIEF DESCRIPTION OF DRAWINGS

FIG. 1 is an external perspective view of a liquid crystal display device that is an example of a display device according to the present invention in which a front case of the device is opened.

FIG. 2 is an external perspective view of the display device shown in FIG. 1 in which the front case is closed.

FIGS. 3A and 3B are sectional views of a main section of a cabinet in which the front case and the back case of the display device shown in FIG. 1 are fitted with each other. FIG. 3A shows a state in which mobile portions are closed, and FIG. 3B shows a state in which the mobile portions are opened outward.

FIGS. 4A and 4B are right side views of the display device shown in FIG. 1. FIG. 4A shows a state in which the front case is opened, and FIG. 4B shows a state in which the front case is closed.

FIG. 5 is an exploded perspective view of an example of the inner structure of the liquid crystal display device.

FIGS. 6A to 6C show a conventional display device. FIG. 6A is a perspective view of the conventional display device in which a cabinet is opened, FIG. 6B is a right side view of the conventional display device shown in FIG. 6A, and FIG. 6C is a right side view of the conventional display device in which the cabinet shown in FIG. 6B is closed.

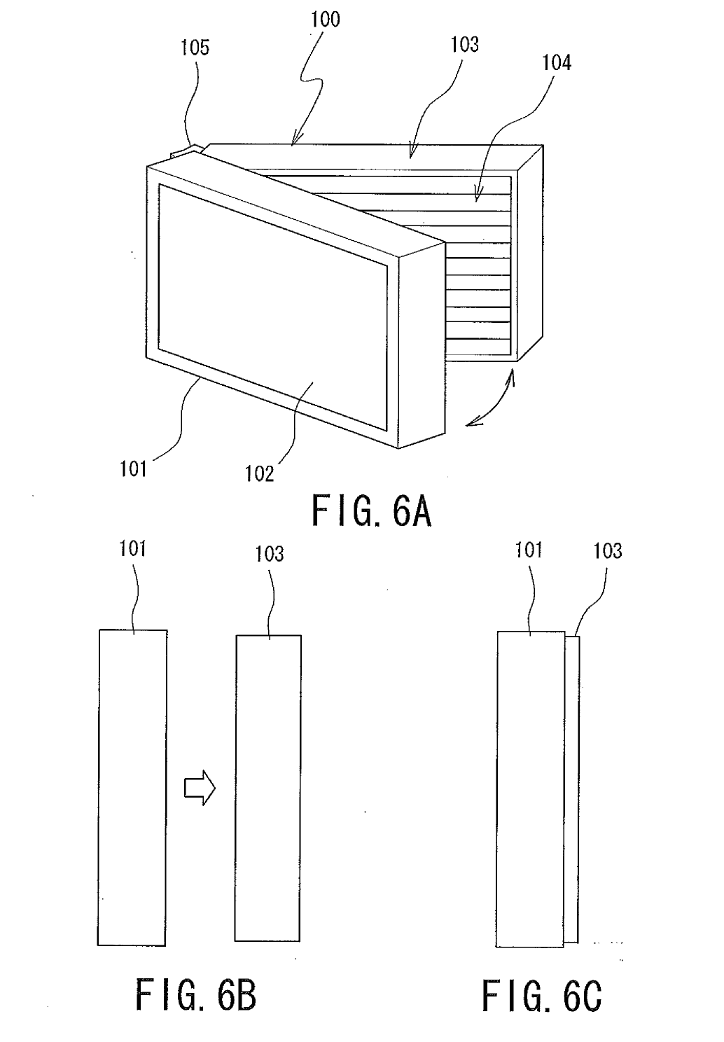

### DESCRIPTION OF EMBODIMENTS

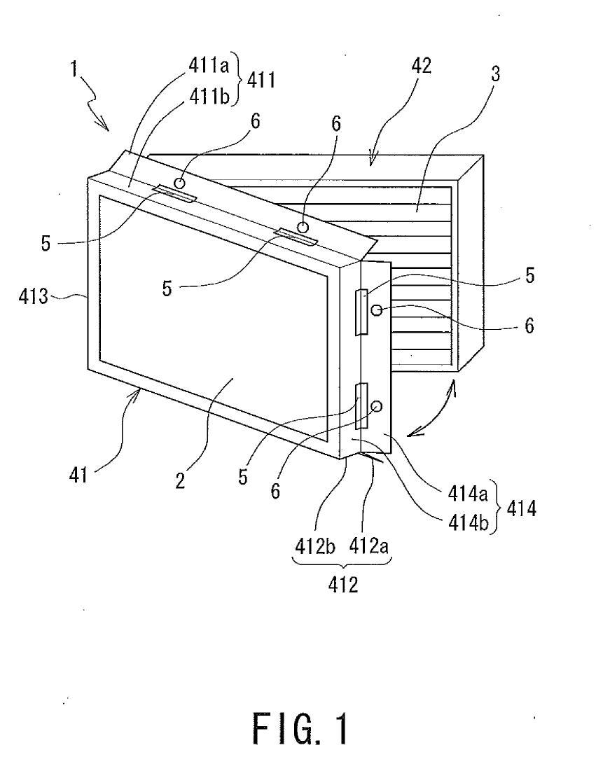

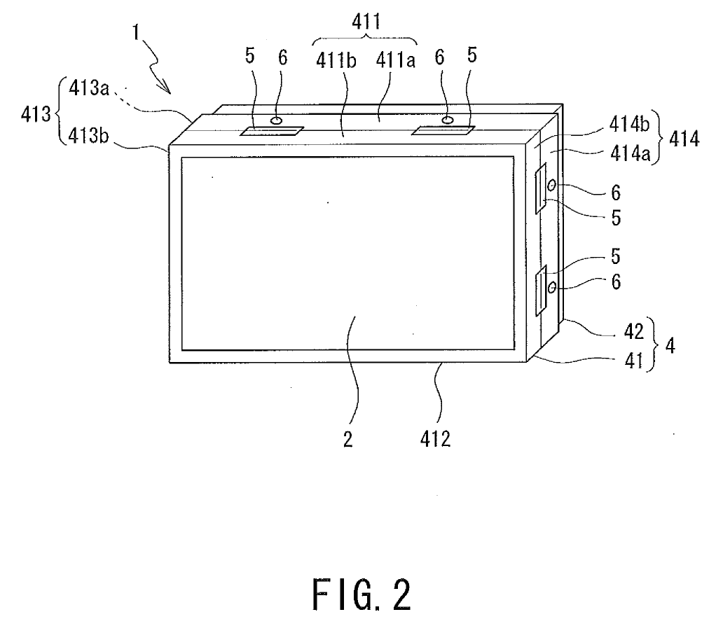

A detailed description of a display device according to the present invention will now be provided with reference to the accompanying drawings. FIG. 1 is an external perspective view of a liquid crystal display device that is an example of the display device according to the present invention in which a front case is opened. FIG. 2 is an external perspective view of the display device shown in FIG. 1 in which the front case is closed. The liquid crystal display device shown in FIG. 1 is a liquid crystal display device in which a liquid crystal panel is equipped with a backlight. As shown in FIGS. 1 and 2, a liquid crystal display device (hereinafter, sometimes referred to simply as a display device) 1 includes a cabinet 4 that accommodates components of the display device 1 such as a liquid crystal panel 2 and a backlight unit 3. The cabinet 4 has a box shape with a square liquid crystal panel surface, and is constituted of a front case 41 (a first case) having an opening surface on the back side and a back case 42 (a second case) having an opening surface on the front side, and the front case 41 and the back case 42 are fitted with each other. In the cabinet 4, the opening surface of the front case 41 is opposed to the opening surface of the back case 42, and the front case 41 and the back case 42 are fitted with each other such that periphery surfaces of the front case 41 cover periphery surfaces of the back case 42.

The front case 41 accommodates the liquid crystal panel 2 that defines a display panel of the display device 1. The back case 42 accommodates the backlight unit 3 that defines a light source for the liquid crystal panel 2. The opening surface on the back side of the front case 41 has an opening over the whole surface in order to fit with the back case 42. The front surface of the front case 41 includes an opening through which the screen of the liquid crystal panel can be seen. The peripheral portion of the opening on the front surface of the front case 41 has the shape of a picture frame. The opening surface on the front side of the back case 42 has an opening, which allows for change and repair of the backlight unit 3.

The front side of the display device 1 according to the present invention refers to a side of the display device 1 on which an image is visibly displayed, and in the preferred embodiment shown in FIGS. 1 and 2, the front side refers to the liquid crystal panel 2 side. The back side of the display device 1 refers to the rear side of the display device 1, and in the preferred embodiment shown in FIGS. 1 and 2, the back side refers to the backlight unit 3 side. Periphery surfaces of the display device 1 refer to a top surface, a bottom surface, a left side surface, and a right side surface that are to be located around the periphery of the liquid crystal panel surface of the display device 1.

Periphery surfaces of the front case 41 include four periphery surface members including a top surface member 411, a bottom surface member 412, a left side surface member 413 (see FIG. 2), and a right side surface member 414. Each of the periphery surface members 411 to 414 is divided into an immobile portion and a mobile portion that are arranged along the back and forth direction of the front case 41 (the front and back direction of the display device 1). Portions of the periphery surface members 411 to 414 at the opening surface side on the back side of the front case 41 define mobile portions 411a, 412a, 413a, and 414a that have hinge structures and are capable of being rotated outward from the display device 1. Portions of the periphery surface members 411 to 414 on the front side of the front case 41 define immobile portions 411b, 412b, 413b, and 414b.

The mobile portions 411a to 414a are connected to the immobile portions 411b to 414b by hinge structures using hinges 5 in such a manner that the mobile portions 411a to 414a are capable of being rotated with respect to the immobile portions 411b to 414b. The mobile portions 411a to 414a are rotated to form an angle from 0 to 180 degrees from the immobile portions 411b to 414b. The hinges 5 are arranged to fix the mobile portions 411a to 414a such that the mobile portions 411a to 414a are capable of being held at an arbitrary angle when the mobile portions 411a to 414a are rotated. In order to hold the mobile portions 411a to 414a at an arbitrary angle, the tightness of the hinges 5 is set at such a degree that rotation is hard to perform. Because the mobile portions 411a to 414a are capable of being held at an arbitrary angle, it is not necessary to support the mobile portions 411a to 414a by hand when fitting the front case 41 and the back case 42 with each other, thereby making the fitting operation easy.

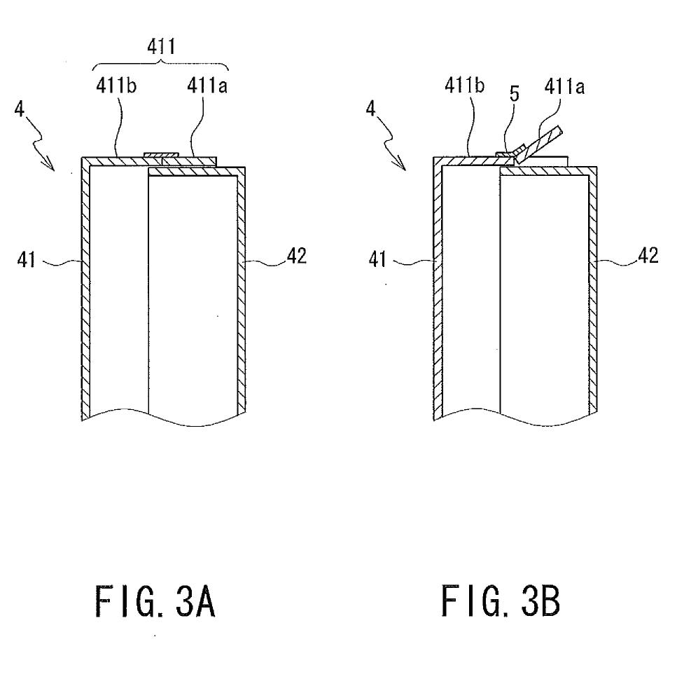

FIGS. 3A and 3B are sectional views of a main section of the cabinet of the display device shown in FIG. 1 in which the front case and the back case are fitted with each other. FIG. 3A shows a state in which the mobile portions are closed, and FIG. 3B shows a state in which the mobile portions are opened outward. As shown in FIGS. 3A and 3B, the top surface member 411 has such a configuration that a width of the mobile portion 411a (a length of the mobile portion 411a in the back and forth direction of the cabinet 4) is slightly shorter than a length of a fitted portion of the back case 42 with the front case 41. In a state that the mobile portion 411a is opened outward by rotation, an end portion on the front side of the back case 42 is slightly fitted with the immobile portion of the front case 41 (see FIG. 3B). Although not shown in FIGS. 3A and 3B, a liquid crystal panel is accommodated in the front case 41. The back case 42 is inserted into the front case 41 to such a position that a space for the liquid crystal panel is left on the front side of the back case 42. Widths of the mobile portions of the periphery surface members other than the top surface member 411 (the periphery surface members 412 to 414) are also slightly shorter than the length of the fitted portion of the back case 42 with the front case 41.

As shown in FIGS. 1 and 2, the mobile portions 411a to 414a are provided with locking members 6 defined by screws arranged to lock the mobile portions 411a to 414a onto the periphery surfaces of the back case 42. The mobile portions 411a to 414a can be locked onto the periphery surfaces of the back case 42 by the locking members 6. The cabinet 4 of the display device 1 shown in FIG. 1 is in such a state that the front case 41 is opened having a rotation axis at the hinge 5 of the left side surface member 413 of the front case 41. In the cabinet 4 shown in FIG. 1, the mobile portion 413a of the left side surface member 413 of the front case 41 is locked onto the left side surface of the back case 42 by the locking members 6. The mobile portion 413a of the left side surface member 413 of the front case 41 is locked onto the left side surface of the back case 42, and the front case 41 is rotated by the hinge structure of the hinge 5. In the display device 1 shown in FIG. 1, instead of the left side surface member 413, any one of the mobile portions of the periphery surface members 411, 412, and 414 may be locked by the locking members 6, and the front case 41 may be opened having the rotation axis at the mobile portion that is located opposed to the locked mobile portion. Locking one of the mobile portions 411a to 414a onto the back case 42 by the locking members 6 allows the periphery surface member to be the rotation axis with reliability.

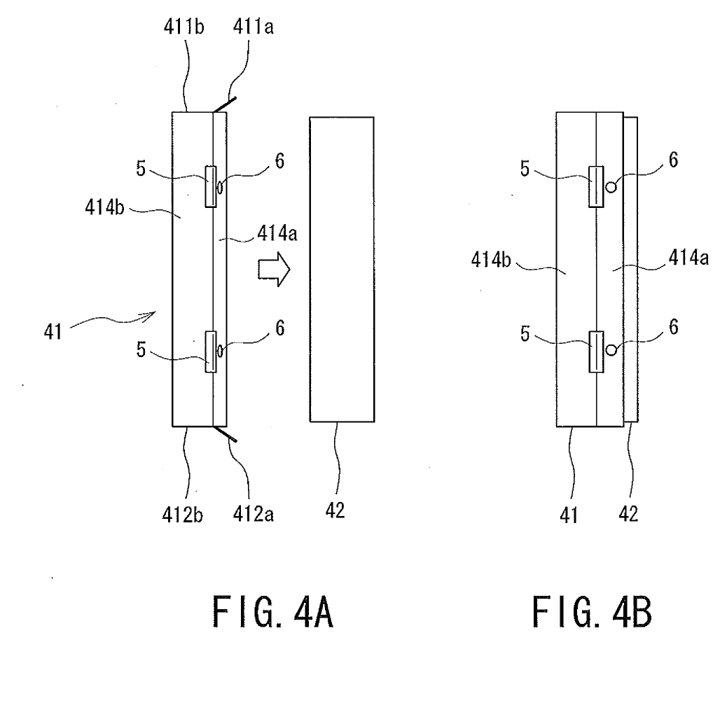

FIGS. 4A and 4B are right side views of the display device 1 shown in FIG. 1. FIG. 4A shows a state in which the front case 41 is opened, and FIG. 4B shows a state in which the front case 41 is closed. As shown in FIG. 4A, the mobile portions 411a, 412a, and 414a except the mobile portion 413a of the left side surface are first rotated outward on the opening surface side of the front case 41. Then, the front case 41 is rotated to reach a given position having the rotation axis at the mobile portion 413a of the right side surface so as to close the front case 41. Finally, as shown in FIG. 4B, the mobile portions 411a, 412a, and 414a are rotated toward the back case 42 and are locked onto the back case 42 by the locking members 6. Thus, the front case 41 and the back case 42 are fitted with each other.

Unlike the conventional case, it is not difficult to fit the front case 41 and the back case 42 with each other at the time of rotating the front case 41 to the given position where the front case 41 is fitted with the back case 42 because the mobile portions on the opening surface of the front case 41 are opened outward. Even if the display device is large and the front case 41 and the back case 42 are to be closely fitted with each other, the cabinet 4 can be easily closed because the fitting state can be easily provided as described above. In contrast, in the conventional case with no mobile portions, a front case having a simple box shape and a back case having a simple box shape are fitted with each other. Thus, periphery surfaces of the front case and periphery surfaces of the back case are brought into contact with each other, and the fitting operation is difficult. If the display device is large and a cabinet is deformed, the fitting operation is extremely troublesome.

The above descriptions are given on a case that the mobile portion 413a of the left side surface of the cabinet 4 is locked, and the front case 41 is rotated having the rotation axis at the left side surface. However, it is essential only that the mobile portion of any one of the periphery surfaces be locked and the periphery surface become the rotation axis of the front case 41. For example, the mobile portion 414a of the right side surface is locked while the mobile portions of the other periphery surfaces are not locked, so that the front case 41 is rotated having the rotation axis at the right side surface and the left side surface becomes the opening side. Alternatively, the mobile portion 411a of the top surface is locked while the mobile portions of the other periphery surfaces are not locked, so that the front case 41 is rotated having the rotation axis at the top surface and the bottom surface becomes the opening side. Alternatively, the mobile portion 412a of the bottom surface is locked while the mobile portions of the other periphery surfaces are not locked, so that the front case 41 is opened and closed having the rotation axis at the bottom surface and the top surface becomes the opening side.

As described above, in the preferred embodiment shown in FIG. 1, by locking the mobile portions of any one of the four periphery surfaces, the periphery surface that is located opposite to the locked mobile portion becomes the opening side. Therefore, the periphery surface that becomes the opening side can be freely selected from among the periphery surfaces. Thus, regardless of the installation site of the display device, maintenance of the inside of the cabinet can be performed. In addition, regardless of the location of the backlight to be changed and the location of the components to be subjected to maintenance, maintenance can be performed more easily because the periphery surface that is most favorable for opening the cabinet can be arbitrarily selected.

A bezel that is used for the liquid crystal panel 2 may be used as the front case 41. The front case 41 is prepared in such a manner that a metal plate material is subjected to press working so as to have the shape of a square box that has one opening surface and provides immobile portions, a metal plate material is subjected to working so as to prepare mobile portions, and the mobile portions are joined to the immobile portions by using hinge members such as hinges. On the other hand, a backlight chassis that is used for the backlight unit 3 may be used as the back case 42. The back case 42 is prepared in such a manner that a metal plate material is subjected to press working so as to have the shape of a square box that has one opening surface. The back case 42 has screw holes (not shown) arranged to engage with the locking members 6.

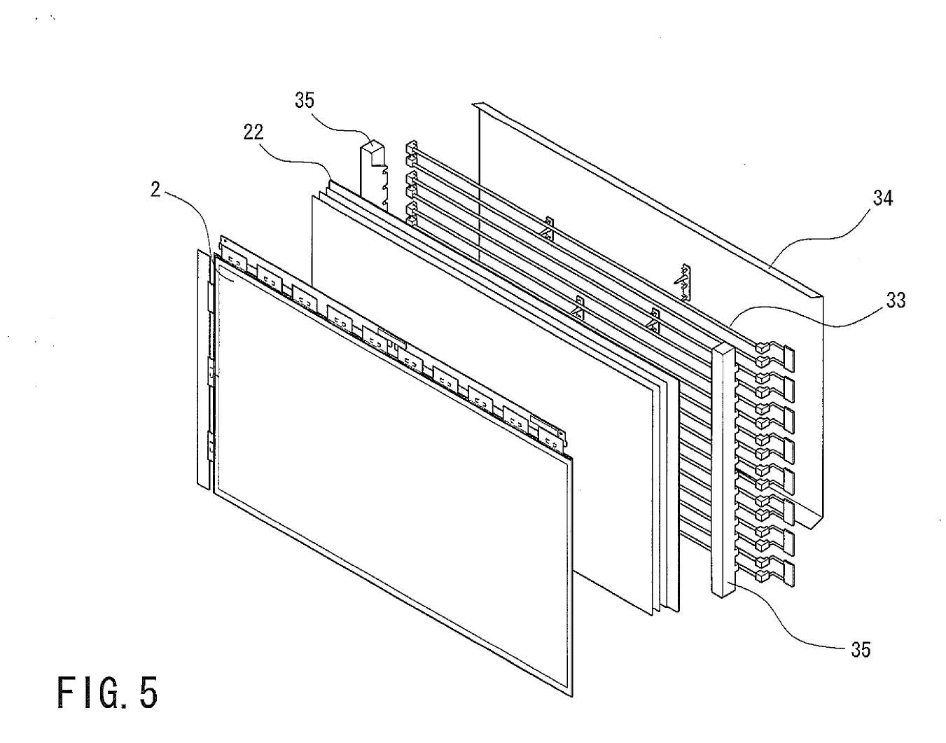

FIG. 5 is an exploded perspective view showing an example of the inner structure of the liquid crystal display device. Components of the liquid crystal display device 1 preferably include cold cathode fluorescent tubes 33 that are light sources of the backlight unit 3, a reflection sheet 34 arranged to reflect light emitted from the cold cathode fluorescent tubes 33, lamp holders 35 disposed at right and left end portions and arranged to hold the cold cathode fluorescent tubes 33, optical sheets 22 arranged to adjust properties of the light emitted from the cold cathode fluorescent tubes 33, and the liquid crystal panel 2 arranged to transmit the light having passed through the optical sheets 22 and visibly display an image. Among these components, the cold cathode fluorescent tubes 33, the reflection sheet 34, and the lamp holders 35 are accommodated in the back case 42, and the liquid crystal panel 2 and the optical sheets 22 are accommodated in the front case 41. The back case 42 accommodates a light source driving circuit board and a light source driving circuit board cover (not shown).

Various types of conventional transmissive or transflective liquid crystal panels may be used for the liquid crystal panel 2, and examples thereof include a commonly-used active matrix liquid crystal panel. The liquid crystal display device 1 may be used for a television receiver. If used for a television receiver, the cabinet accommodates components such as a tuner, a loudspeaker mechanism, and an electric power supply at given positions. These components are accommodated in the back case, for example.

Although the display device according to the preferred embodiment shown in FIG. 1 has the fitting structure such that the periphery surfaces of the front case 41 cover the periphery surfaces of the back case 42, the display device according to the present invention may have a fitting structure such that the periphery surfaces of the back case 42 cover the periphery surfaces of the front case 41, and the periphery surfaces of the back case 42 are constituted of the immobile portions and the mobile portions. In addition, although the display device according to the preferred embodiment uses the cabinet having a horizontally long box shape, the display device according to the present invention may use a cabinet having a vertically long box shape.

The display device according to the preferred embodiment shown in FIG. 1 is configured such that all of the periphery surfaces are provided with the mobile portions. However, according to the present invention, it is essential only that at least two of the periphery surfaces be provided with the mobile portions.

A decorative panel (not shown) may be attached detachably to the periphery surfaces of the front case, so that the decorative panel usually hides the hinges 5 and the locking members 6.

The display device according to the present invention is applicable not only to the liquid crystal display device but also to various types of display devices.

1. A display device comprising:
a cabinet that includes a first case and a second case that are fitted with each other, and accommodates components of the display device, wherein
an opening surface of the first case is opposed to the second case,
the first case and the second case are fitted with each other in such a manner that periphery surfaces of the first case cover periphery surfaces of the second case,
each of at least two of the periphery surfaces of the first case is divided into an immobile portion and a mobile portion that are arranged along a back and forth direction,
the mobile portions are positioned on the opening surface side of the first case, and
the mobile portions are capable of being rotated outward from the first case with respect to the immobile portions.

2. The display device according to claim 1, wherein the mobile portions comprise locking members arranged to lock the mobile portions onto the second case.

3. The display device according to claim 1, wherein the at least two of the periphery surfaces of the first case comprise a right side surface of the first case that is constituted of an immobile portion and a mobile portion, and a left side surface of the first case that is constituted of an immobile portion and a mobile portion.

4. The display device according to claim 1, wherein the at least two of the periphery surfaces of the first case comprise a top surface of the first case that is constituted of an immobile portion and a mobile portion, and a bottom surface of the first case that is constituted of an immobile portion and a mobile portion.

5. The display device according to claim 1, wherein the mobile portions are capable of being held at an arbitrary angle when the mobile portions are rotated.

6. The display device according to claim 1, wherein a liquid crystal panel is accommodated in the first case, and a backlight unit is accommodated in the second case.
